(19) United States
(12) Patent Application Publication
(10) Pub. No.: US 2023/0300658 A1
(43) Pub. Date: Sep. 21, 2023

(54) RESOURCE UNIT ALLOCATION FOR TRIGGER BASED SENSING MEASUREMENT INSTANCES AND CHANNEL STATE INFORMATION FEEDBACK SUPPORT IDENTIFIER

(71) Applicant: HUAWEI TECHNOLOGIES CO., LTD., Shenzhen (CN)

(72) Inventors: Jung Hoon SUH, Kanata (CA); Osama ABOUL-MAGD, Kanata (CA); Yan XIN, Kanata (CA); Kwok Shum AU, Kanata (CA)

(73) Assignee: HUAWEI TECHNOLOGIES CO., LTD., SHENZHEN (CN)

(21) Appl. No.: 18/120,695

(22) Filed: Mar. 13, 2023

Related U.S. Application Data
(60) Provisional application No. 63/320,919, filed on Mar. 17, 2022.

(51) Int. Cl. H04W 24/10; H04B 7/06

(52) U.S. Cl. CPC H04W 24/10; H04B 7/0626

(57) ABSTRACT

There are provided methods and apparatus related to setting up sensing measurement instances and to allocating resource units (RUs) between sensing responders in a sensing measurement instance. There is provided a channel state information (CSI) feedback (FB) support subfield can be provided in a sensing measurement parameters field, which may be used to allow a device to indicate whether it can compute CSI FB information and feedback. There is further provided, RU allocation re-use across multiple phases of a sensing phase which may enable later trigger frames to omit RU allocation information. There are further provided responder-to-initiator (R2I) null data packets (NDPs) which include information indicative of the device transmitting the packet in a signal (SIG) field of the NDP.

### CROSS-REFERENCE TO RELATED APPLICATIONS

The application claims the benefit of and priority to U.S. provisional patent application No. 63/320,919 filed on Mar. 17, 2022, entitled “RESOURCE UNIT ALLOCATION FOR TRIGGER BASED SENSING MEASUREMENT INSTANCES AND CHANNEL STATE INFORMATION FEEDBACK SUPPORT IDENTIFIER”, the entire contents of which are incorporated herein by reference.

### FIELD

The present disclosure pertains to the field of communication networks, and particularly to methods and field formats related to sensing measurement instances.

### BACKGROUND

The IEEE 802.11bf (11 bf) standard is intended to modify existing wireless local area network (WLAN) standards to enhance sensing capabilities through IEEE 802.11-compliant waveforms. Using IEEE 802.11bf, a station (STA) can detect features (e.g., range, velocity, angular, motion, presence or proximity, gesture, etc.) of intended targets (e.g., objects, humans, animals, etc.) in an environment (e.g., house, office, room, vehicle, enterprise, etc.) using received Wi-Fi signals.

A Wi-Fi sensing session is initiated by a STA which serves as the sensing initiator. The sensing session generally has a setup phase to establish and exchange operational parameters of the session and a measurement phase during which sensing measurements are performed. The sensing session then has a reporting phase, during which sensing measurements are reported to or obtained by the sensing initiator, followed by a termination phase which ends the sensing session. During the setup phase, the sensing initiator and one or more sensing responders may negotiate operational parameters for the sensing instance. During the measurement phase, a sensing initiator and one or more sensing responders may communicate with each other over a set of resource units (RUs). However, certain details about the allocation of RUs are missing in the IEEE 802.11bf draft standard. Therefore, there is a need for improved methods and field formats related to sensing measurement instances which obviate or mitigate one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

The present disclosure provides methods and apparatus related to setting up sensing measurement instances and to allocating resource units (RUs) between sensing responders in a sensing measurement instance. In one aspect, a channel state information (CSI) feedback (FB) support subfield is provided in a sensing measurement parameters field. The CSI FB support subfield may be used to allow a device to indicate whether it can compute CSI FB information and feedback. The present disclosure also provides for RU allocation re-use across multiple phases of a sensing phase. An RU allocation may be signalled during a polling phase in a sensing polling trigger frame, and this RU allocation may be re-used in a trigger frame (TF) sounding phase and a null data packet announcement (NDPA) sounding phase. This RU allocation re-use may enable later trigger frames to omit RU allocation information. The present disclosure also provides for responder-to-initiator (R2I) null data packets (NDPs) which include information on the device transmitting the packet in a signal (SIG) field of the NDP. This may allow a device receiving the NDP to identify the device which transmitted the NDP.

One aspect of the present disclosure provides a method including transmitting, by z AP or z STA, a sensing measurement setup frame, the sensing measurement setup frame including a sensing measurement parameter field, the sensing measurement parameter field including a channel state information (CSI) feedback (FB) support subfield, wherein a value associated with the CSI FB support field is indicative of whether the AP or the STA can provide CSI FB information and feedback. The CSI FB support subfield may be one bit. The sensing measurement parameter field may also include a role subfield, a measurement report type subfield, and an immediate feedback subfield. A value of the CSI FB support subfield may be set to 0 if the AP or the STA cannot compute CSI FB information and feedback. A value of the CSI FB support subfield may be set to 1 if the AP or the STA can compute CSI FB information and feedback. The role subfield may be separated into a transmission (TX) subfield and a reception (RX) subfield. The role subfield may be two bits.

According to another aspect, an apparatus is provided, where the apparatus includes: a memory, configured to store a program; a processor, configured to execute the program stored in the memory, and when the program stored in the memory is executed, the processor is configured to perform one or more of the methods described herein.

In another aspect, a computer readable medium is provided, where the computer readable medium stores program code executed by a device, and the program code is used to perform one or more of the methods described herein.

According to another aspect, a chip is provided, where the chip includes a processor and a data interface, and the processor reads, by using the data interface, an instruction stored in a memory, to perform one or more of the methods described herein.

Other aspects of the disclosure provide for apparatus, and systems configured to implement one or more of the methods disclosed herein. For example, wireless stations (STAs) and access points (APs) can be configured with machine readable memory containing instructions, which when executed by the processors of these devices, configures the devices to perform one or more of the methods disclosed herein.

Embodiments have been described above in conjunction with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 illustrates a protocol of a trigger-based sensing measurement instance, according to an aspect of the present disclosure.

FIG. 2 illustrates a null data packet announcement sounding phase including the report phase, according to an aspect of the present disclosure.

FIG. 3 illustrates a sensing measurement parameters element field format, according to an aspect of the present disclosure.

FIG. 4 illustrates a sensing measurement parameters field subfield format, according to an aspect of the present disclosure.

FIG. 5 illustrates a sensing measurement parameters field subfield format, according to an aspect of the present disclosure.

FIG. 6 is a schematic diagram of an electronic device that may perform any or all of operations of the methods and features explicitly or implicitly described herein, according to different embodiments of the present disclosure.

It will be noted that throughout the appended drawings, like features are identified by like reference numerals.

### DETAILED DESCRIPTION

The IEEE 802.11bf standard is intended to add wireless local area network (WLAN) sensing (SENS) capabilities to allow a station (STA) to perform WLAN sensing and obtain measurement results. A sensing initiator is a STA which initiates a WLAN sensing session. The sensing initiator may also be a proxy sensing initiator. These sensing sessions generally have four phases: a setup phase, a measurement phase, a reporting phase, and a termination phase.

During the setup phase, the sensing initiator and one or more sensing responders may negotiate operating attributes for a sensing instance. These negotiations may include transmitting sensing measurement setup frames between the sensing initiator and one or more sensing responders. Sensing measurement setup request frames and sensing measurement setup response frames are two types of sensing measurement setup frames which may be transmitted during this negotiation. Each sensing measurement setup frame may include a sensing measurement parameters element, which itself may include a sensing measurement parameters field. In some aspects of the present disclosure, it may be advantageous to include a channel state information (CSI) feedback (FB) support subfield in the sensing measurement parameters field. The CSI FB support subfield may indicate whether the sensing initiator or sensing responder can provide CSI FB information and feedback. The CSI FB support subfield may be a one-bit subfield, with a value of 0 indicating an inability to provide CSI FB information and feedback and with a value of 1 indicating an ability to provide CSI FB information and feedback.

During the measurement phase of a sensing instance, a sensing initiator may receive transmissions from a plurality of sensing responders during one or more of a polling phase, during a trigger frame (TF) sounding phase, and during a null data packet announcement (NDPA) sounding phase. These transmissions may be transmitted on one or more resource units (RUs).

In one aspect of the present disclosure, the sensing responders may use the same RUs in one or more of the polling phase and also in the TF sounding phase and/or the NDPA sounding phase. During the polling phase, the sensing initiator may transmit a sensing polling trigger frame to a plurality of sensing responders. This trigger frame may include an RU allocation between the sensing responders. The sensing responders may use their allocated RUs in not only the polling phase, but also in one or more of the TF sounding phase and the NDPA sounding phase. During the TF sounding phase, a sensing responder may transmit a responder-to-initiator (R2I) null data packet (NDP). The NDP may not include information on which the sensing responder is transmitting the packet, but if the packet is sent on the RU(s) allocated to a particular sensing responder, the sensing initiator may be able to determine which sensing responder sent the packet based on the RU(s) used to transmit the packet. During the NDPA sounding phase, the sensing initiator may transmit a sensing trigger report frame. If the sensing responders are configured to re-use the RU allocation from the sensing polling trigger frame, the sensing initiator may be configured to omit or not include an RU allocation in the sensing trigger report frame.

In another aspect of the present disclosure, the sensing responders may be configured to indicate their identity in each R2I NDP. This may allow the sensing responders to use different RU(s) during the TF sounding phase than they were assigned in the polling phase, but still allow the sensing initiator to identify which sensing responder is transmitting which R2I NDP. Typically, an R2I NDP may not include an indication of the identity of the sender of the R2I NDP because the NDP does not include media access control (MAC) data. Instead, the sensing responders may be configured to transmit an indication of their identity, such as an association identifier (AID), in a signal (SIG) field of each R2I NDP that the sensing responder transmits. Similarly, the sensing initiator may be configured to use the SIG field of the R2I NDPs received by the sensing initiator in order to determine which device (for example, which sensing responder) transmitted the packet.

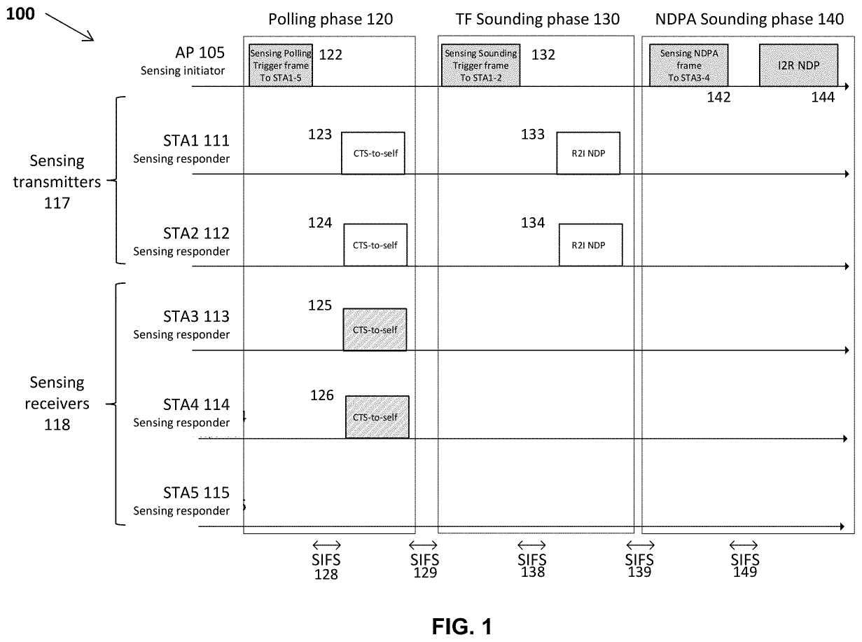

FIG. 1 is an illustration 100 of the protocol of a trigger-based (TB) sensing measurement instance, according to an aspect of the present disclosure. A TB sensing measurement instance may be used when an AP is the sensing initiator or the proxy sensing initiator and where one or more non-AP STAs are the sensing responders. Here, AP 105 is the sensing initiator and STAs 1-5 111, 112, 113, 114, 115 are sensing responders. In this sensing measurement instance, STAs 1 and 2 111, 112 are sensing transmitters 117 while STAs 3-5 113, 114, 115 are sensing receivers 118. The sensing management instance includes a polling phase 120 and can include a TF sounding phase 130 and a NDPA sounding phase 140.

During the polling phase 120, the AP 105 transmits a sensing polling trigger frame 122 to STAs 1-5 111, 112, 113, 114, 115. The trigger frame 122 checks the availability of the STAs 111, 112, 113, 114, 115 that are expected to participate in the TB sensing measurement instance. The sensing polling trigger frame 122 may include an RU allocation for the STAs 111, 112, 113, 114, 115, with each RU being allocated to a single STA. However, it will be understood that in some circumstances, multiple STAs may be scheduled in one RU for example through the use multi-user multiple-in multiple-out (MU-MIMO) technology or other suitable technology. The STAs addressed by a trigger frame may request to participate in the TB sensing measurement instance by responding with a CTS-to-self (clear to send to self) frame in their designated RU allocation. In this sensing measurement instance, STAs 1-4 111, 112, 113, 114 respond to the trigger frame 122 with CTS-to-self messages 123, 124, 125, 126. These CTS-to-self messages may be transmitted simultaneously, after a short interframe space (SIFS) period 128 has elapsed.

In the TF sounding phase 130, the AP 105 transmits a sensing sounding trigger frame 132 to each of the sensing transmitters 117, which are STA1 111 and STA2 112 in this measurement instance. The trigger frame 132 solicits NDP transmissions 133, 134 from the STAs 111, 112 to perform sensing measurements. The sensing sounding trigger frame 132 may be transmitted after a SIFS period 129 has elapsed, following the polling phase 120. After SIFS 138 has elapsed, STA1 111 responds with R2I NDP 133 while STA2 112 responds with R2I NDP 134.

Generally, the R2I NDPs do not carry MAC data, and thus the transmitter address (TA) is missing. This may make it impossible for AP 105 to identify the senders of the R2I NDPs 133, 134.

In one aspect, the same RU allocation for each of the STAs may be used across some or all the TB sensing sounding period which may allow the AP 105 to identify the senders of the R2I NDPs 133, 134. For example, an RU allocation may be scheduled in the sensing polling trigger frame 122 during the polling phase 120. This RU allocation may be used both during the polling phase 120 and during the TF sounding phase 130. For example, during TF sounding phase 130, STA1 111 may transmit R2I NDP 133 in the RU(s) allocated to it in sensing polling trigger frame 122, and STA2 112 may do the same with R2I NDP 134. AP 105 may then identify the STA which transmitted each R2I NDP based on the RU(s) used to transmit the packet.

In another aspect, each STA may include their AID or another indication of the STA ID in the SIG field of the R2I NDP. For example, STA1 111 may include its AID in the SIG field of R2I NDP 133, which may enable the AP 105 to identify the sender of R2I NDP 133. Providing an indication of the transmitting device in the SIG field may allow these transmitting devices to use different RUs during the polling phase 120 and the TF sounding phase 130.

In the NDPA sounding phase 140, the AP 105 transmits a sensing NDPA frame 142 to the sensing responders, which are STA3 113 and STA4 114 in this measurement instance. After SIFS 149, the announcement frame 142 is followed by the AP 105 transmitting an initiator-to-responder (I2R) NDP 144.

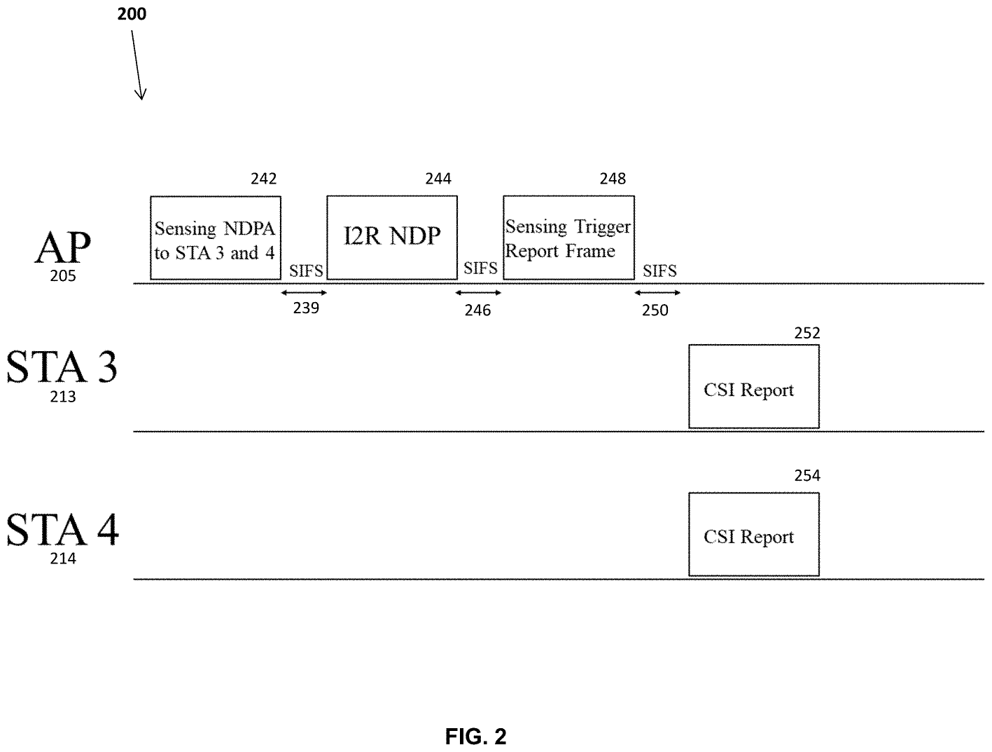

FIG. 2 is an illustration 200 of a NDPA sounding phase including the report phase, according to an aspect of the present disclosure. In the NDPA sounding phase, the AP 205, which is a sensing transmitter, transmits a sensing NDPA frame 242 to STA3 213 and STA4 214. These two STAs 213, 214, as in illustration 100, are sensing receivers and have responded in a polling phase of the TB sensing measurement instance. The sensing NDPA frame 242 may contain STA info fields which specify all of the STAs that will use the NDP sent by AP 205, which in this example are STA3 213 and STA4 214.

After a SIFS 239, the AP 205 further sends an I2R NDP 244 to be used by STA3 213 and STA4 214. After a SIFS 246, the AP 205 transmits a sensing trigger report frame 248. After another SIFS 250, the STAs 213, 214 simultaneously send channel state information reports based on the I2R NDP 244, with STA3 213 sending CSI report 252 and STA4 214 sending CSI report 254.

In one aspect, the STAs may use the same RUs in the NDPA sounding phase as they did in the polling phase. For example, STA3 213 may be assigned one or more RUs in a sensing polling trigger frame during the polling phase and STA3 213 may use those one or more RUs to transmit CSI report 252. If the STAs use the same RUs in the NDPA sounding phase as they did in the polling phase, then the sensing trigger report frame 248 may not need to provide any RU allocations associated with the STAs, since the RU allocation will have already been provided during the polling phase.

According to embodiments, a WLAN sensing instance may be initiated by a sensing initiator and may include one or more sensing responders. The sensing initiator and a sensing responder may engage in a negotiation process to exchange and agree on operational attributes associated with the sensing instance. These operational attributes can include the roles of the sensing initiator and the roles of the sensing responder, measurement report types, and other operational parameters. Among other attributes, these parameters can determine the role(s) of the sensing responder as a sensing receiver, a sensing transmitter, or both a sensing transmitter and a sensing receiver.

This negotiation process may begin with the sensing initiator transmitting a sensing measurement setup request frame to the sensing responder. This request frame may include a sensing measurement parameters element which describes proposed operational attributes for the sensing instance. The sensing responder may reply with a sensing measurement setup response frame sent to the sensing initiator. The sensing measurement setup response frame may accept the operational attributes proposed in the request frame or may propose alternative sensing measurement parameters in a sensing measurement parameters element. Both a sensing measurement setup request frame and a sensing measurement setup response frame may be types of sensing measurement setup frames.

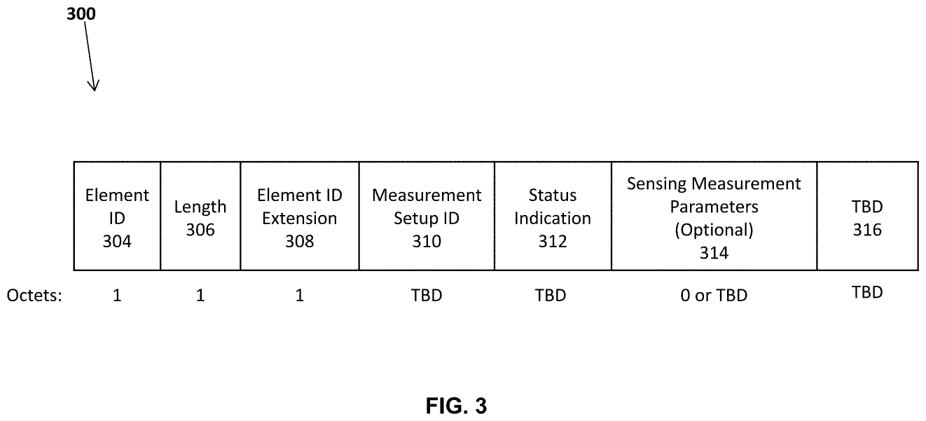

FIG. 3 is an illustration of a sensing measurement parameters element field format 300, according to an aspect of the present disclosure. The field format 300 includes: an element ID field 304, a length field 306, an element ID extension field 308, a measurement setup ID field 310, a status indication field 312, a sensing measurement parameters field 314, and can also include other fields 316 which may be subsequently defined.

Each field of the sensing measurement parameters element field format 300 may be allocated a certain size. The element ID field 304, length field 306, and the element ID extension field 308 may each be assigned 1 octet. Each octet is 8 bits or 1 byte. The measurement setup ID field 310, the status indication field 312, and the sensing measurement parameters field 314 can each be assigned a length which may also be an octet or another size which may be subsequently defined.

The sensing measurement parameters field 314 may optionally be excluded from the sensing measurement parameters element field format 300 when it is not necessary. For example, if a sensing responder transmits a sensing measurement setup response frame which accepts the operational attributes proposed by a sensing initiator, it may be unnecessary to include the sensing measurement parameters field 314. The status indication field 312 may include a value which indicates whether a sensing measurement parameters field 314 is present. For example, a status indication field 312 value of 3 may be used to reject proposed operational attributes but to indicate that preferred attributes are included in the sensing measurement parameters field 314.

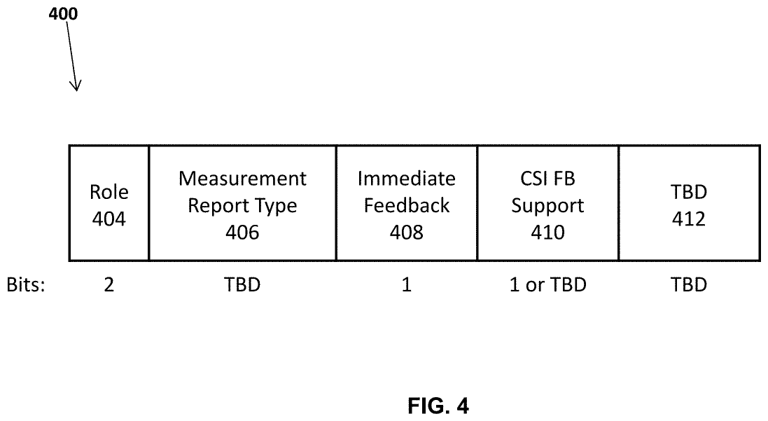

FIG. 4 illustrates a sensing measurement parameters field subfield format 400, according to an aspect of the present disclosure. The subfield format 400 includes: a role subfield 404, a measurement report type subfield 406, an immediate feedback subfield 408, a CSI FB support subfield 410, and can also include other subfields 412 which may be subsequently defined.

Each subfield of the sensing measurement parameters field subfield format 400 may be allocated a certain size. The role subfield 404 may be allocated 2 bits while the immediate feedback subfield 408 may be allocated 1 bit. The measurement report type subfield 406 and the CSI FB support subfield 410 can each be assigned a length which may also be one bit or another size which may be subsequently defined. It will be understood that while particular sizes of these subfields have been identified, there are merely to provide examples and could be other appropriate sizes.

The CSI FB support subfield 410 may be an operation element of each station in a sensing instance. The CSI FB support subfield 410 may be used to indicate whether the sensing responder is able to compute CSI FB information and feedback. For example, a CSI FB support subfield 410 value of 0 may indicate that the sensing responder is not able to compute this information while a value of 1 may indicate that the sensing responder is able to compute this information.

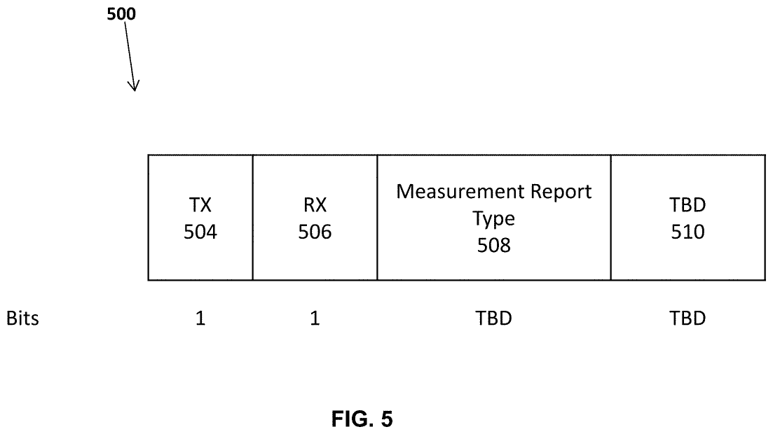

FIG. 5 illustrates another sensing measurement parameters field subfield format 500, according to an aspect of the present disclosure. The sensing measurement parameters field subfield format 500 illustrated in FIG. 5, is somewhat similar to that as illustrated in FIG. 4, however in particular the role subfield 404 illustrated in FIG. 4, has been separated into a transmission (TX) subfield 504 and a reception (RX) subfield 506. The sensing measurement parameters field subfield format 500 further includes a measurement report type subfield 508 and can also include other subfields 510 which may be subsequently defined.

Each subfield of the sensing measurement parameters field subfield format 500 may be allocated a certain size. The TX subfield 504 may be allocated 1 bit and the RX subfield 506 may also be allocated 1 bit. The measurement report type subfield 508 can be assigned a length which may also be one bit or another size which may be subsequently defined. It will be understood that while particular sizes of these subfields have been identified, there are merely to provide examples and could be other appropriate sizes.

In some embodiments, a CSI FB support subfield may be provided in the sensing measurement parameters field subfield format 500 by being assigned one or more bits present in one or more of the subfields 510 that are to be defined. Similar to that as defined above with respect to FIG. 4, a CSI FB support subfield defined in the sensing measurement parameters field subfield format 500 illustrated in FIG. 5, may be an operation element of each station in a sensing instance. A CSI FB support subfield may be used to indicate whether the sensing responder is able to compute CSI FB information and feedback. For example, a CSI FB support subfield value of 0 may indicate that the sensing responder is not able to compute this information while a value of 1 may indicate that the sensing responder is able to compute this information.

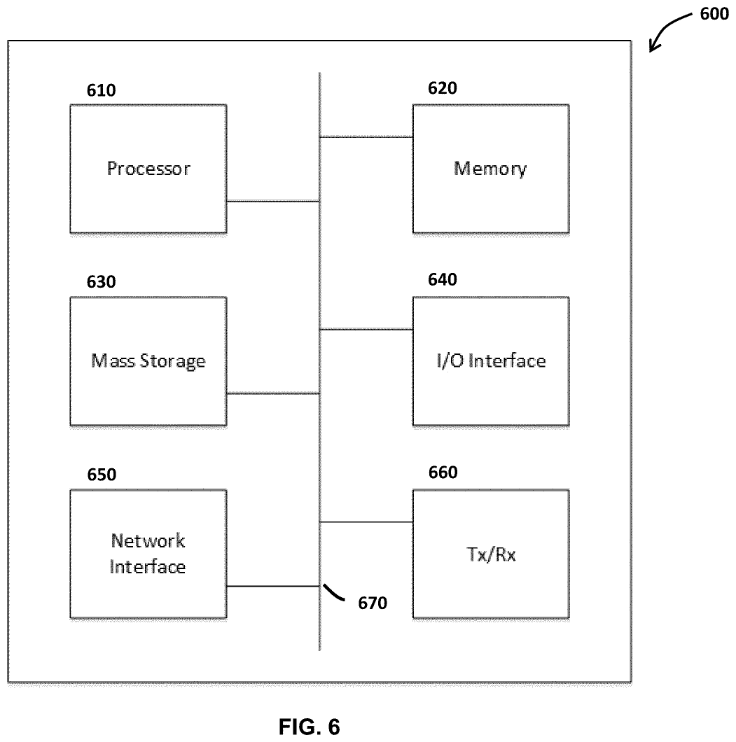

FIG. 6 is a schematic diagram of an electronic device 600 that may perform any or all of operations of the above methods and features explicitly or implicitly described herein, according to different embodiments of the present disclosure. For example, a computer equipped with network functions may be configured as electronic device 600. In some embodiments, the electronic device 600 may be a user equipment (UE), an AP, a STA, or the like as appreciated by a person skilled in the art.

As shown, the electronic device 600 may include a processor 610, such as a central processing unit (CPU) or specialized processors such as a graphics processing unit (GPU) or other such processor unit, memory 620, non-transitory mass storage 630, input-output interface 640, network interface 650, and a transceiver 660, all of which are communicatively coupled via bi-directional bus 670. According to certain embodiments, any or all the depicted elements may be utilized, or only a subset of the elements. Further, electronic device 600 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 620 may include any type of non-transitory memory such as static random-access memory (SRAM), dynamic random-access memory (DRAM), synchronous DRAM (SDRAM), read-only memory (ROM), any combination of such, or the like. The mass storage element 630 may include any type of non-transitory storage device, such as a solid-state drive, hard disk drive, a magnetic disk drive, an optical disk drive, USB drive, or any computer program product configured to store data and machine executable program code. According to certain embodiments, the memory 620 or mass storage 630 may have recorded thereon statements and instructions executable by the processor 610 for performing any of the method operations described above.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

According to embodiments, the present disclosure may be implemented as a chip, where the chip includes a processor and a data interface, and the processor reads, by using the data interface, an instruction stored in a memory, to perform one or more of the methods the described herein.

For example, a chip can be configured as a system on a chip or system-on-chip (SOC) which is readily understood to be an integrated circuit or package that integrates most or all components of a computer or other electronic system. These components can include a central processing unit (CPU), memory interfaces, on-board memory, on-chip input/output devices, input/output interfaces and secondary storage interfaces, potentially alongside other components such as radio modems and a graphics processing unit (GPU) on a single substrate or microchip. A SOC may contain one or more of digital, analog, mixed signal radio frequency signal processing functions, as would be readily understood.

As another example, a chip can be configured as a wireless chipset, which as is readily understood, is a piece of internal hardware designed to allow a device to communicate with another wireless-enabled device. This type of chipset can be found inside computers as well as a number of other wireless products, which can include an access point (AP), mobile station (STA), user equipment (UE) or other wireless device as would be readily understood.

It will be appreciated that, although specific embodiments of the technology have been described herein for purposes of illustration, various modifications may be made without departing from the scope of the technology. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, personal digital assistant (PDA), or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disc read-only memory (CD-ROM), USB flash disk, or a removable hard disk. The software product includes instructions that enable a computer device (personal computer, server, or network device) to execute the methods provided in the embodiments of the present disclosure. For example, such an execution may correspond to a simulation of the logical operations as described herein. The software product may additionally or alternatively include instructions that enable a computer device to execute operations for configuring or programming a digital logic apparatus in accordance with embodiments of the present disclosure.

In some embodiments, there is provided a method including a sensing initiator transmitting a sensing polling trigger frame which includes a RU allocation between one or more sensing responders. The method also includes the sensing initiator receiving a transmission from one of the sensing responders and determining an identity of the sensing responder that transmitted the transmission. The sensing initiator may be an access point (AP) and the sensing responders may be stations (STAs).

In some embodiments, receiving the transmission can include receiving the transmission during either a TF sounding phase and a NDPA sounding phase, and determining the identity can include determining the identity of the sensing responder based on the RU allocation. Receiving the transmission may include receiving a R2I NDP during the TF sounding phase. Receiving the transmission may include receiving a CSI report during the NDPA sounding phase and the method may further include the sensing initiator, prior to receiving the transmission from the sensing responder, transmitting a sensing trigger report frame which does not include a second RU allocation between the one or more sensing responders.

In some embodiments, the transmission may be an R2I NDP and determining the identity of the sensing responder includes determining the identity of the sensing responder that transmitted the R2I NDP based on an indication of the identity in a signal (SIG) field of the R2I NDP. The indication of identity may be an association identifier (AID) in the SIG field of the R2I NDP.

In some embodiments there is provided a method including determining, by an AP or a STA, a value for a CSI feedback (FB) support subfield. The method also includes transmitting, by the AP or the STA, a sensing measurement setup frame, the sensing measurement setup frame including a sensing measurement parameter field, the sensing measurement parameter field including the CSI FB support subfield, which can be used as an identifier. The CSI FB support subfield may be one bit. The sensing measurement parameter field may also include a role subfield, a measurement report type subfield, and an immediate feedback subfield. A value of the CSI FB support subfield may be set to 0 if the AP or the STA cannot compute CSI FB information and feedback. A value of the CSI FB support subfield may be set to 1 if the AP or the STA can compute CSI FB information and feedback.

According to some embodiments, an apparatus is provided, where the apparatus includes: a memory, configured to store a program; a processor, configured to execute the program stored in the memory, and when the program stored in the memory is executed, the processor is configured to perform one or more of the methods described herein.

In some embodiments, a computer readable medium is provided, where the computer readable medium stores program code executed by a device, and the program code is used to perform one or more of the methods described herein.

According to some embodiments, a chip is provided, where the chip includes a processor and a data interface, and the processor reads, by using the data interface, an instruction stored in a memory, to perform one or more of the methods described herein.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any modifications, variations, combinations, or equivalents that fall within the scope of the present invention.

What is claimed is:

1. A method comprising:
transmitting, by an access point (AP) or a station (STA), a sensing measurement setup frame, the sensing measurement setup frame including a sensing measurement parameter field, the sensing measurement parameter field including a channel state information (CSI) feedback (FB) support subfield;
wherein a value associated with the CSI FB support field is indicative of whether the AP or the STA can provide CSI FB information and feedback.

2. The method of claim 1, wherein the CSI FB support subfield is one bit.

3. The method of claim 1, wherein the sensing measurement parameter field further comprises a role subfield, a measurement report type subfield, and an immediate feedback subfield.

4. The method of claim 1, wherein the value is 0 when the AP or the STA cannot compute CSI FB information and feedback; and
wherein the value is 1 when the AP or the STA can compute CSI FB information and feedback.

5. The method of claim 3, wherein the role subfield is separated into a transmission (TX) subfield and a reception (RX) subfield.

6. The method of claim 3, wherein the role subfield is two bits.

7. An apparatus comprising:
at least one processor and at least one machine-readable medium storing executable instructions which when executed by the at least one processor configure the apparatus to:
transmit a sensing measurement setup frame, the sensing measurement setup frame including a sensing measurement parameter field, the sensing measurement parameter field comprising a channel state information (CSI) feedback (FB) support subfield;
wherein a value associated with the CSI FB support field is indicative of whether the apparatus can provide CSI FB information and feedback.

8. The apparatus of claim 7, wherein the CSI FB support subfield is one bit.

9. The apparatus of claim 7, wherein the sensing measurement parameter field further comprises a role subfield, a measurement report type subfield, and an immediate feedback subfield.

10. The apparatus of claim 7, wherein the value is 0 when the apparatus cannot compute CSI FB information and feedback; and
wherein the value is 1 when the apparatus can compute CSI FB information and feedback.

11. The apparatus of claim 9, wherein the role subfield is separated into a transmission (TX) subfield and a reception (RX) subfield.

12. The apparatus of claim 9, wherein the role subfield is two bits.

13. A non-transitory computer-readable medium storing executable instructions which when executed by a processor of a device configure the device to:
transmit a sensing measurement setup frame, the sensing measurement setup frame including a sensing measurement parameter field, the sensing measurement parameter field including a channel state information (CSI) feedback (FB) support subfield;
wherein a value associated with the CSI FB support field is indicative of whether the device can provide CSI FB information and feedback.

14. The non-transitory computer-readable medium of claim 13, wherein the CSI FB support subfield is one bit.

15. The non-transitory computer-readable medium of claim 13, wherein the sensing measurement parameter field further comprises a role subfield, a measurement report type subfield, and an immediate feedback subfield.

16. The non-transitory computer-readable medium of claim 13, wherein the value is 0 when the apparatus cannot compute CSI FB information and feedback; and
wherein the value is 1 when the apparatus can compute CSI FB information and feedback.

17. The non-transitory computer-readable medium of claim 15, wherein the role subfield is separated into a transmission (TX) subfield and a reception (RX) subfield.

18. The non-transitory computer-readable medium of claim 15, wherein the role subfield is two bits.
